(19) United States
(12) Patent Application Publication
(10) Pub. No.: US 2009/0190582 A1
(43) Pub. Date: Jul. 30, 2009

(54) SYSTEM AND METHOD FOR STREAMING MEDIA IN MASTER OR SLAVE MODE WITH EASE OF USER CHANNEL CONFIGURATION

(75) Inventors: Raghu NAMBIATH, Germantown, MD (US); Gaurant TRIVEDI, Germantown, MD (US); Sanjay BHAL, Boyds, MD (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/022,220

(22) Filed: Jan. 30, 2008

(51) Int. Cl. H04L 12/56

(52) U.S. Cl. 370/389

(57) ABSTRACT

A streaming media receiving box in a packet network includes a first transceiver to transmit and receive communications over a packet network; a second transceiver to transmit and receive communications over a local area network; and a processor cooperating with the first and second transceivers. The processor can receive a selection to provide a media stream. Further, the processor can operate in a master mode, including responsive to the selection, receiving the media stream from the packet network over the first transceiver; and transmitting the received media stream to another streaming media box over the second transceiver. An alternative slave mode embodiment can be provided. Some embodiments can include both master and slave modes, and can switch between slave and master modes depending on availability of the media stream from another streaming media box operating in master mode. Optionally, ease of user channel configuration is provided.

### TECHNICAL FIELD

The technical field relates in general to communication networks, and more specifically to streaming media in connection with a voice over packet network.

### BACKGROUND

The term “streaming media” generally refers to content that is constantly delivered by a content provider to an end user over a telecommunications network. Streaming media therefore can include television channels and radio broadcasts delivered over the Internet, as well as other varieties of content.

Currently, for example, some streaming media available over the Internet can be viewed on a traditional television set using interface devices such as a set top box. More particularly, instead of being delivered through traditional broadcast and cable formats, streaming media such as television channels can be received through technologies used for computer networks.

Problems can be experienced, unfortunately, when viewing or listening to streaming media delivered over the Internet, particularly in comparison to traditional broadcast and cable media. One such problem is a lack of continuity due to network conditions and interruptions.

Consider that there are frequently multiple televisions in a home, each of which can obtain its own media stream for the desired broadcast. Since the multiple televisions in the home can all simultaneously receive their respective media streams over the same gateways, bandwidth problems can be experienced.

Furthermore, switching between television channels (or radio stations) on the Internet requires changing the URL, rather than easily switching between “channels” as with conventional television viewing. The large number of possible sources of streaming media on the Internet increases the awkwardness of such switching.

### SUMMARY

Accordingly, one or more embodiments provide a streaming media receiving box in a packet network that includes a first transceiver operable to transmit and receive communications over at least a portion of a packet network; a second transceiver operable to transmit and receive communications over at least a portion of a local area network; and a processor cooperatively operable with the first transceiver and the second transceiver. The processor is configured to facilitate receiving a selection to provide a media stream. Further, the processor is configured for operating in a master mode, including responsive to the selection, receiving the media stream from the packet network in accordance with the first transceiver; and transmitting the received media stream to another streaming media box in accordance with the second transceiver. Methods, systems, and computer-readable media with instructions implementing the foregoing are also provided.

One or more embodiments also can provide a streaming media receiving box in a packet network that includes a first transceiver operable to transmit and receive communications over at least a portion of a local area network; and a processor cooperatively operable with the first transceiver. The processor is configured for receiving a selection to provide a media stream. Also, the processor is configured for operating in a slave mode, responsive to the selection, including sending a request to another streaming media box for the media stream and receiving the media stream from the another streaming media box in accordance with the first transceiver. Methods systems, and computer-readable media with instructions implementing the foregoing are also provided.

According to various embodiments, a streaming media receiving box can be provided with both the master mode and the slave mode, and can switch between the slave mode and the master mode depending on the availability of the media stream from another streaming media receiving box operating in master mode.

One or more other embodiments can provide a computer-implemented method, implemented on a streaming media box, for providing channel configuration in connection with a streaming media box on a packet network. The method includes receiving a selection of media stream from a remote control, wherein the selection is a pre-defined channel which is designated to correspond to a universal resource locator (URL) from which the media stream is received. Also included is determining the URL corresponding to the pre-defined channel. Also provided for is changing a URL selection of the streaming media box to the determined URL. Systems, devices, and computer-readable media with instructions implementing the foregoing are also provided.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a diagram illustrating a simplified and representative environment associated with a network having a streaming media receiving box and a packet network;

FIG. 2 is a block diagram illustrating portions of a streaming media receiving box;

FIG. 3 is a block diagram illustrating portions of a personal computer;

FIG. 4 is a flow chart illustrating a procedure for providing channel configuration for streaming media; and

FIG. 5 is a flow chart illustrating a procedure for receiving streaming media in master or slave mode.

### DETAILED DESCRIPTION

In overview, the present disclosure concerns communication networks, more particularly referred to as packet networks or voice over packet (VOP) networks, such as may be associated with networks supporting voice communication between wireless and/or wire line devices, and local area networks used therewith. Such communication networks may provide additional services such as data communications, signal, and/or video services. Such communications can be used to provide streaming media to wireless and/or wire line devices, for example by breaking a media stream into communication packets and forwarding the media stream as the communication packets. More particularly, various inventive concepts and principles are embodied in systems, devices, and methods therein for receiving a media stream via a packet network or VOP network.

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As further discussed herein below, various inventive principles and combinations thereof are advantageously employed to reduce the inconvenient experiences which sometimes occur during real time streaming over an Internet protocol link. Such inconveniences occur due to bandwidth limitations and changing channels, for example.

Further in accordance with exemplary embodiments, there is provided an easier and a more friendly experience in viewing streaming media, for example on par with that experienced during traditional television viewing. Considering that most homes have multiple television sets which receive streaming media over the same gateway, using master and slave modes can avoid redundant processing delays and processing overheads. A streaming media receiving box can check for a master already receiving the desired media stream. While in a slave mode, the streaming media receiving box can request, receive and play the active channels already buffered at the master streaming media receiving box. Optionally, the streaming media receiving box can be used instead of a gateway and the gateway can be omitted.

Furthermore, another solution provides a capability of linking a channel to a URL (and optionally to a title), optionally in connection with video quality resolution. For example, a remote can include access to a list of channel selections (and optionally titles) so that a user can select a channel and optionally a video quality resolution. The channels are associated with URLs. Thus, the user can switch URLs of a streaming media receiving box in a friendlier manner, similar to changing channels of a traditional television. Furthermore, by providing easily selectable resolution quality, bandwidth requirements can be adjusted to facilitate parallel uses of bandwidth over the same gateway, e.g., simultaneous streaming of interactive games and audio.

Additionally, a streaming media receiving box can support faster channel switching and reduce delays while channels are viewed by pre-buffering the video channels, where “pre-buffering” means that the video channel is buffered prior to being transmitted for final viewing or to another streaming media receiving box. The pre-buffering length can be based on (1) fixed length such as one or two minutes, or (2) optimal length based on the bandwidth availability and network congestion. The pre-buffering decision by the streaming media receiving box can be based on multiple configurations, for example (1) a list of favorite channels which will be pre-buffered, or (2) a viewer profile; the streaming media receiving box can predict the probable channels which a viewer will likely watch on a particular date and time and can pre-buffer for the interval. The number of channels for which pre-buffering will be done can be based on bandwidth availability and network congestion. Buffering can provide a continuous flow of the media stream.

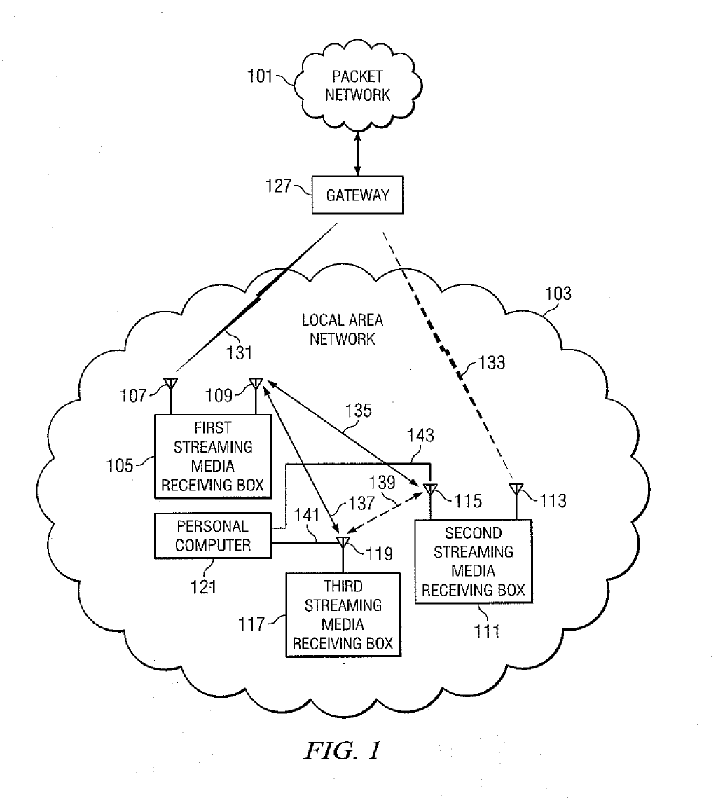

Referring now to FIG. 1, a diagram illustrating a simplified and representative environment associated with a network having a streaming media receiving box and a packet network will be discussed and described. A packet network 101 and a local area network 103 are illustrated. The local area network 103 transmits and receives communications to and from the packet network 101 over a gateway 127.

The local area network 103 in the illustration includes a first streaming media receiving box 105, a second streaming media receiving box 11, a third streaming media receiving box 117, and a personal computer 121. However, different combinations of devices may be included in the local area network 103. Typically, the local area network 103 is included in a home or office, and can include wireless and/or wireline connections. Also, the gateway 127 can be omitted and one of the streaming media receiving boxes 105, 111 can be used instead.

Each of the streaming media receiving boxes 105, 111, 117 is a device typically used to receive streaming media packet communications, for example, a device commonly referred to as a streaming set-top box, a set-top box, or a computer. The first and second streaming media receiving boxes 105, 111 each include first transceivers 107, 113 which can transmit and receive communications 131, 133 to/from the packet network 101 via the gateway 127. The first, second and third streaming media receiving boxes 105, 111, 117 each include second transceivers 109, 115, 119 which can transmit and receive communications 135, 137, 139 to/from the local area network 103 between the streaming media receiving boxes 105, 111, 117 as well as communications 141, 143 with one or more other devices in the local area network such as the illustrated personal computer 121.

The personal computer 121 is representative of a device such as a personal digital assistant, a personal assignment pad, a laptop, or a personal computer, or equivalents thereof, provided such devices are arranged and constructed for operation in the local area network 103.

Because the first and second streaming media receiving boxes 105, 111 include the first transceivers, they can each receive a media stream from the packet network 101 via the gateway 127. Because the first, second, and third streaming media receiving boxes 101, 111, 117 include the second transceivers, they can each receive a media stream from the local area network 103 such as from each other. Consequently, the first or second streaming media receiving box 105, 111 can act as a master for receiving the media stream from the packet network 101, whereas the first, second, and/or third streaming media receiving boxes 105, 111, 117 can act as slaves for receiving the media stream from whichever streaming media receiving box is acting as the master. The use of the master/slave configuration reduces the need for duplicate communications of the same media stream to the gateway 127, thereby reducing bandwidth requirements.

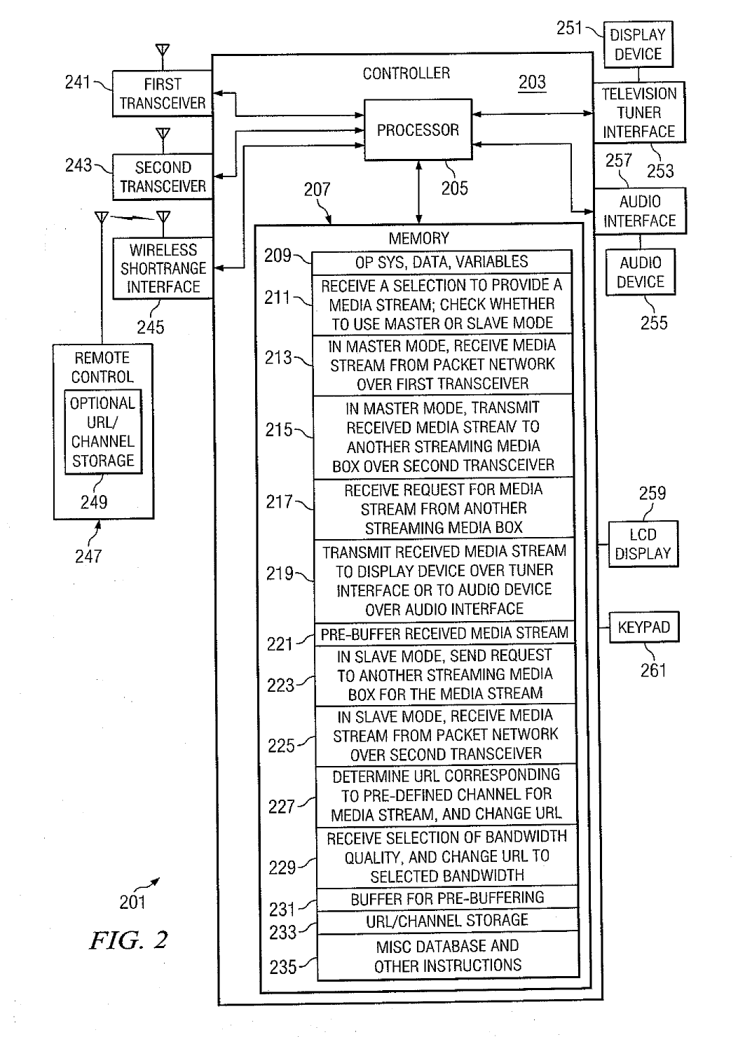

Referring now to FIG. 2, a block diagram illustrating portions of a streaming media receiving box will be discussed and described. A streaming media receiving box 201 may include and one or more controllers 203. Included in the controller 203 is a processor 205, and a memory 207. The streaming media receiving box 201 can also include various other optional input/output devices such as a liquid crystal display (LCD) 259, a keypad 261, and/or other user interfaces.

The streaming media receiving box 201 may be equipped with receivers and transmitters, and/or transceivers, and/or other communication ports, represented here by a first transceiver 241 and second transceiver 243. The first transceiver 241 can communicate over a wireless or wired connection with packet network, a voice over packet (VOP) network, or a voice over IP (VoIP) network. The second transceiver 243 can communicate over a wireless or wired connection with other streaming media boxes on a local area network, for example in connection with Home Plug, HPNA (home phone networking alliance), Bluetooth, and/or other standards. It should be noted that the plural transceivers, transmitters and/or transceivers, such as the illustrated first and second transceivers 241, 243, can be configured as a single physical transceiver; such single transceiver can communicate over a wireless or wired connection. Also, the streaming media receiving box 201 may be equipped with a wireless short range interface 245, for receiving short range wireless transmissions from a remote control 247 using, for example, infrared (IR), radio-controlled, Bluetooth and similar standards. The processor 207 can be connected to the first and second transceivers 241, 243 and wireless short range interface 245 using components which are well understood and therefore will not be discussed herein.

The streaming media receiving box 201 may include a television tuner interface 253 for connection to a display device 251 such as a television or monitor, and/or an audio interface 257 for connection to an audio device 255 such as a speaker. The processor 205 can be connected to the television tuner interface 253 and/or audio interface 257 to transmit/receive signals therebetween using components, all of which are well understood and therefore will not be discussed herein. The display device 251 and the audio device 255 are generally referred to herein as an “output device.”

The processor 205 may comprise one or more microprocessors and/or one or more digital signal processors. The memory 207 may be coupled to the processor 207 and may comprise a read-only memory (ROM), a random-access memory (RAM), a programmable ROM (PROM), an electrically erasable read-only memory (EEPROM), and/or a flash memory. The memory 207 may include multiple memory locations for storing, among other things, an operating system, data and variables 209 for programs executed by the processor 205; computer programs for causing the processor to operate in connection with various functions such as receiving 211 a selection to provide a media stream and checking whether to use master or slave mode, in master mode: receiving 213 a media stream from the packet network over the first transceiver, in master mode: transmitting 215 the received media stream to another streaming media box over the second transceiver, receiving 217 a request for the media stream from another streaming media box, transmitting 219 the received media stream to the display device over the tuner interface or to the audio device over the audio interface, pre-buffering 221 the received media stream, in slave mode: sending 223 a request to another streaming media box for the media stream, in slave mode: receiving 225 the media stream from the packet network over the second transceiver, determining 227 a URL corresponding to a pre-defined channel for the media stream and changing the URL, receiving 229 a selection of bandwidth quality and changing the URL to the selected bandwidth, and/or other processing; a buffer 231 for pre-buffering; storage 233 for the URL/channel information; and a database 235 for other information used by the processor 205. The computer programs may be stored, for example, in ROM or PROM and may direct the processor 205 in controlling the operation of the streaming media receiving box 201. Each of these functions of the computer programs is discussed by way of example below.

The processor 205 may be programmed for receiving 211 a selection to provide a media stream and checking whether to use master or slave mode. The selection of the media stream can be received from, for example, the remote control 247, from the keypad 261, or over the first or second transceiver 241, 243. The selection may be in the form of a URL or indicator such as a channel corresponding to a URL, from which a media stream is intended to be received. Upon receiving the selection, the processor 205 can check whether it will be using master mode or slave mode. For example, if another streaming media receiving box is already receiving the media stream, as revealed by polling or interaction with a gateway, the processor 205 will be using slave mode; otherwise, the processor 205 will be using master mode. More particularly, for example, when the streaming media box is requested to play the media stream, it can transmit a broadcast poll to the other streaming media box nodes in the network, and the other streaming media box nodes in the network can respond with information on the media stream available at each respective other streaming media box nodes. Also, the processor 205 cannot use master mode unless it is equipped with the first transceiver 241 for connecting to a packet network. Note that a transition to master mode/slave mode can be made depending on the availability of media streams from other streaming media boxes.

The processor 205 may be programmed for, in master mode, receiving 213 a media stream from the packet network over the first transceiver. The media stream is received over the first transceiver 241 in accordance with known techniques. Optionally, the media stream can be pre-buffered while it is received 221 in the buffer 231, in accordance with known buffering techniques. The pre-buffered media stream stored in the buffer 231 can be used to reduce sporadic interruptions not only for outputting the media stream at the streaming media receiving box 201, but also for transmitting the media stream to another streaming media receiving box operating in slave mode.

An optimum size of the buffer 231 can be determined by providing sufficient storage to buffer a media stream for one or two minutes, where the longer time is selected where the network condition is poor or the bandwidth requirement is high quality. Also, predictive pre-buffering can be incorporated. That is, based on a user's historical viewing pattern on particular days and times or a list of favorite channels, the streaming media can be pre-buffered for a predetermined time prior to the user actually selecting the streaming media. Thus, predictive pre-buffering can begin at 7:57 PM for a media stream that the user historically begins viewing at 8 PM, or predictive pre-buffer can be operating using one or more channels from the list of favorite channels.

Also, the processor 205 may be programmed for, in master mode, transmitting 215 the received media stream to another streaming media box over the second transceiver. Since there is at least one streaming media receiving box operating in slave mode, the processor 205 can transmit the received media stream over the second transceiver 243 to the slave(s) over the local area network. If the processor 205 is pre-buffering the received media stream in the buffer 231, the media stream can be output from the buffer 231.

Accordingly, the processor can be further configured for pre-buffering the received media stream in a buffer, wherein the received media stream which is transmitted to another streaming media box is transmitted from the buffer.

Note that it is possible for the processor 205 to be receiving more than one media stream, if the processor 205 is acting in master mode with respect to two different media streams. The plural received media streams can be pre-buffered in the buffer 231.

The processor 205 may be programmed for receiving 217 a request for the media stream from another streaming media box. The request for the media stream can be received over the second transceiver 243 from the local area network in any conventional format, to indicate the request for the media stream. For example, the request can be a packet with an indicator of the type of request (that is, a media stream request) and an indicator of the particular media stream (such as a URL or channel). The processor can respond with an ACK, a NAK, or (if receiving the requested media stream) can begin transmitting the requested media stream to the other streaming media box from the second transceiver 243 over the local area network.

Accordingly, the streaming media receiving box can provide for receiving a request for the media stream from the another streaming media box, wherein the transmitting of the received media stream to another streaming media box is responsive to the request.

The processor 205 may be programmed for transmitting 219 the received media stream to the display device 251 over the tuner interface 253 or to the audio device 255 over the audio interface 257. The techniques for providing a media stream to the display device 251 and audio device 255 are known to those of skill in the art and will not be further explained.

Accordingly, the streaming media receiving box can further include a television tuner interface, wherein the processor is configured for transmitting the received media stream to a display device over the tuner interface; and/or the streaming media receiving box can further include an audio interface, wherein the processor is configured for transmitting the received media stream to an audio device over the audio interface.

Furthermore, the processor 205 may be programmed for, in slave mode, sending 223 a request for the media stream to another streaming media box. The request for the media stream can be as discussed above, and can be transmitted to the master streaming media box on the local area network over the second transceiver 243. Once the processor 205 has sent the request for the media stream to the master streaming media box, the processor 205, now in slave mode, can begin receiving 225 the media stream from the packet network over the second transceiver 243. The received media stream can then be transmitted 219 to the display device 251 and/or audio device 255 as described above.

Also, the processor 205 may be programmed for determining 227 a URL corresponding to a pre-defined channel for the media stream and changing the URL, so that the processor receives the media stream corresponding to the URL. The techniques for indicating the URL of the media stream to be received via the first transceiver 241 over the packet network are conventional. If the process 205 is to be receiving plural media streams, the processor can indicate the plural URL's corresponding to the respective plural media streams. The selection of the media stream which is received can be a URL; alternatively, the selection can be a channel and/or a title and thus the URL may need to be determined. The URL can be determined for example by referring to the URL/channel storage 233, wherein URLs are indexed by channel and/or title. The URL/channel storage 233 can be built as a list by interfacing with the user or can be downloaded from the packet network or from another device on the local area network such as a personal computer.

Accordingly, one or more embodiments provide a streaming media receiving box in a packet network, for example operating in master mode. The streaming media receiving box includes a first transceiver operable to transmit and receive communications over at least a portion of a packet network; a second transceiver operable to transmit and receive communications over at least a portion of a local area network; and a processor cooperatively operable with the first transceiver and the second transceiver. The processor is configured to facilitate receiving a selection to provide a media stream; operating in a master mode, including responsive to the selection, receiving the media stream from the packet network in accordance with the first transceiver; and transmitting the received media stream to another streaming media box in accordance with the second transceiver.

Accordingly, one or more embodiments provide a streaming media receiving box in a packet network, for example operating in slave mode. The streaming media receiving box includes a transceiver operable to transmit and receive communications over at least a portion of a local area network; and a processor cooperatively operable with the transceiver. The processor is configured to facilitate receiving a selection to provide a media stream; operating in a slave mode, responsive to the selection, including sending a request to another streaming media box for the media stream and receiving the media stream from the another streaming media box in accordance with the transceiver.

Accordingly to a further embodiment, the streaming media receiving box operating in slave mode can further include another transceiver operable to transmit and receive communications over at least a portion of a packet network. The processor can be cooperatively operable with the another transceiver, and can be responsive to the selection, checking over the transceiver whether another streaming media box is already receiving the media stream from the packet network, and operating in the slave mode if the another streaming media box is already receiving the media stream; otherwise, operating in a master mode, including receiving the media stream from the packet network in accordance with the another transceiver.

According to a further embodiment, the master mode can include receiving a request from the another streaming media box for the media stream and transmitting the received media stream to the another streaming media box in accordance with the transceiver.

Optionally, the remote control 247 can include memory 249 having stored therein URLs corresponding to channels and/or titles. Hence the selection of the media stream transmitted from the remote control 247 can readily indicate a desired URL, while the use of the URL is transparent to the user. The remote can include a hot key which provides a list of channel selections, optionally with title, and the user can select the channel he is interested in. The details of the channels can be downloaded from a publicly available URL so that a new user can have a list of channels already available based on the downloaded publicly available URL.

Accordingly, the streaming media receiving box can further include a wireless short range interface operable to receive communications from a remote control, wherein the selection of the media stream is received from the remote control over the wireless short range interface, and the selection is a pre-defined channel which is designated to correspond to a universal resource locator (URL) from which the media stream is received.

Optionally, the URL/channel storage 233, 249 in the processor 205 or in the remote control 247 can further include URLs corresponding to selectable bandwidth quality, such as high definition and standard definition. Thus, by selecting a channel and bandwidth quality, a different URL can be used corresponding to the desired bandwidth quality.

The processor 205 can receive 229 a selection of bandwidth quality, for example from the remote control 247 over the wireless short range interface 245 or from a slave over the second transceiver 243, and can change the URL to correspond to the selected bandwidth. Accordingly, the processor can be further configured for receiving a selection of bandwidth quality, and changing the media stream to the selected bandwidth quality.

The user may invoke functions accessible through a user input device, represented here by the keypad 261. The user input device may comprise one or more of various known input devices, such as the illustrated keypad 261, a computer mouse, a touchpad, a touch screen, a trackball, and/or a keyboard. The LCD display 259 is representative of a display which may present information to the user by way of a conventional liquid crystal display or other visual display.

It should be understood that various logical groupings of functions are described herein. Different realizations may omit one or more of these logical groupings. Likewise, in various realizations, functions may be grouped differently, combined, or augmented. Furthermore, variations can omit functions. For example, a variation of the streaming media receiving box 201 can operate only as a slave; such variation can omit the first transceiver 241 as well as the master mode functions 213, 215, 217. Also, a variation of the streaming media receiving box 201 can operate as a master but not a slave; this variation can omit the slave mode functions 223, 225. A further variation of the master streaming media receiving box is not used to output the media stream for display or audio but is only used as a master; this variation further can omit the display device 251, the television tuner interface 253, the audio device 255, the audio interface 257, and related functions 219. Still another variation omits the pre-buffering 221 function as well as the buffer 231 for pre-buffering.

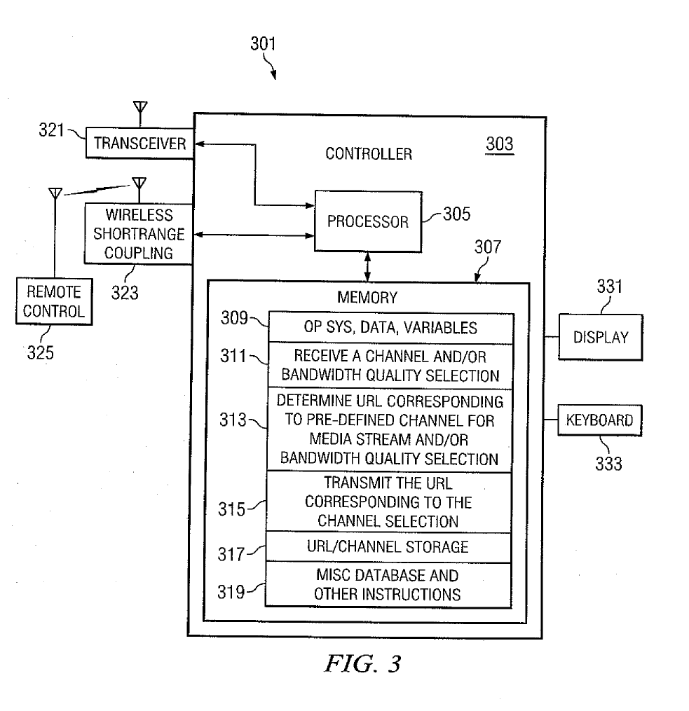

Furthermore, instead of the remote control 247, a personal computer or similar device can be used and can connect to the streaming media receiving box 201 via the wireless short range interface 245 or the second transceiver 243 to provide the selection. Conveniently, the personal computer can also be used to personalize and/or expand URLs/channel and bandwidth selections. An example of such a personal computer is discussed in connection with FIG. 3. The remote control (or variations) and wireless short range interface 245 optionally can be omitted.

Referring now to FIG. 3, a block diagram illustrating portions of a personal computer will be discussed and described. A personal computer 301 may include and one or more controllers 303; the controller 303 includes a processor 305, and a memory 307. Many other components of the personal computer 301 are well understood and accordingly are omitted from this discussion. The personal computer 301 can also include various other optional input/output devices such as a display 331, a key board 333, and/or other user interfaces.

The personal computer 301 may be equipped with receivers and transmitters, and/or transceivers, and/or other communication ports, represented here by a transceiver 321. The transceiver 321 can communicate the local area network, as discussed above. The personal computer 301 also may be equipped with a wireless short range interface 323 of the type discussed above, for receiving short range wireless transmissions from a remote control 325, also as discussed above.

The processor 305 may comprise one or more microprocessors and/or one or more digital signal processors. The memory 307 may be coupled to the processor 307 and may comprise a read-only memory (ROM), a random-access memory (RAM), a programmable ROM (PROM), an electrically erasable read-only memory (EEPROM), and/or a flash memory. The memory 307 may include multiple memory locations for storing, among other things, an operating system, data and variables 309 for programs executed by the processor 305; computer programs for causing the processor to operate in connection with various functions such as receiving 311 a channel and/or bandwidth quality selection, determining 313 a URL corresponding to a pre-defined channel for the media stream and/or bandwidth quality selection, transmitting 315 the URL corresponding to the channel selection; storage 317 for the URL/channel information; and a database 319 for other information used by the processor 305. Each of these functions of the computer programs is discussed by way of example below.

The processor 305 may be programmed for receiving 311 a channel and/or bandwidth quality selection. The selection can be provided from a remote control 325 via the wireless short range interface 323, or can be provided via user interaction with the personal computer 301. Because the processor 305 can include storage 317 having stored therein URLs corresponding to channels and/or titles, the selection of the media stream transmitted from the remote control 247 can indicate a desired channel, so that the personal computer 301 can look up the URL from the URL/channel storage 317. More particularly, the remote control 325 can perform a URL fetch from the personal computer 301 and can transmit the fetched URL to the streaming media receiving box.

The URL/channel storage 317 and use thereof can be as described above in connection with FIG. 2. Alternatively, the remote control 325 can indicate a desired URL. As described above, the URL/channel storage 317 in the processor 305 can further include URLs corresponding to selectable bandwidth quality, so that a different URL can be used corresponding to the desired bandwidth quality. Consequently, the processor 305 may be programmed for determining 313 a URL corresponding to a pre-defined channel for the media stream and/or bandwidth quality selection.

The processor 305 may be programmed for transmitting 315 the URL corresponding to the channel selection, for example to the streaming media receiving box on the local area network over the transceiver 321. Use of personal computers 301 as the channel selector can allow multiple users to have different URL/channel storage on their own personal computers 301, resulting in customized channels although a shared streaming media receiving box.

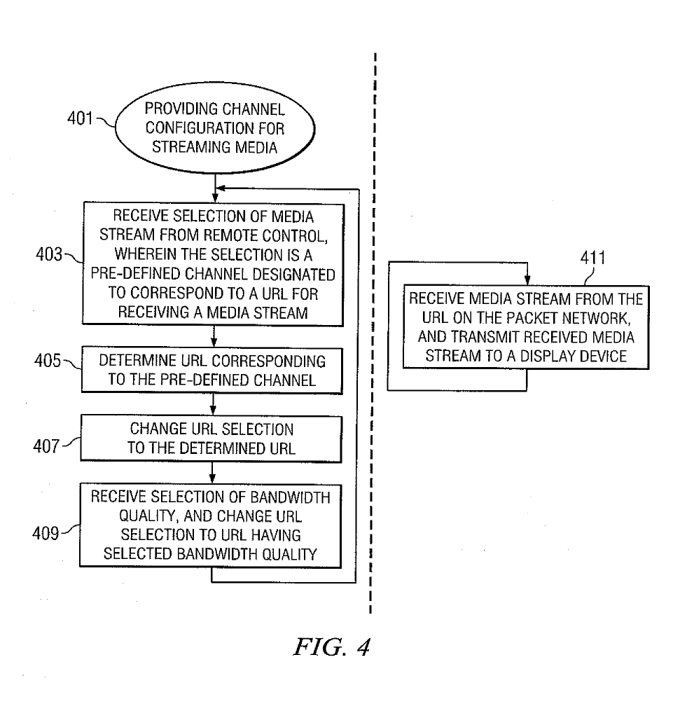

Referring now to FIG. 4, a flow chart illustrating a procedure 401 for providing channel configuration for streaming media will be discussed and described. The procedure can advantageously be implemented on, for example, a processor of a controller of a streaming media receiving box described in connection with FIG. 2, and/or a personal computer described in connection with FIG. 3, and/or other apparatus appropriately arranged.

In overview, the procedure 401 for providing the channel configuration can include receiving 403 a selection of a media stream, wherein the selection is a pre-defined channel; determining 405 a URL corresponding to the pre-defined channel; changing 407 a URL selection to the determined URL; optionally receiving 409 a selection of bandwidth quality and changing the URL to reflect the bandwidth quality; and optionally receiving 411 a media stream from the URL on the packet network and transmitting the received media stream to a display device. Each of these is discussed in more detail below.

The procedure 401 can include receiving 403 a selection of a media stream, wherein the selection is a pre-defined channel. The pre-defined channel was previously designated as corresponding to a URL from which a media stream can be received. A channel can be a number (e.g., 1-999) or a station name (e.g., ESPN, CNN).

The procedure 401 can include determining 405 a URL corresponding to the pre-defined channel. For example, the URL can be determined from a look-up table having the pre-defined channel and the corresponding URL. The look-up table can be downloaded from a separate computer (such as a program guide from a service provider), or can be created and/or modified by a user. The procedure 401 can include changing 407 a URL selection to the determined URL, as described above.

Optionally, the procedure 401 can include receiving 409 a selection of bandwidth quality and changing the URL to reflect the bandwidth quality. Some media streams are available in different quality resolutions, which affect the bandwidth. Hence, a particular media stream can use different URLs for different bandwidth qualities. The URL corresponding to the pre-defined channel with the selected bandwidth quality can be determined from the look-up table, which optionally indicates the bandwidth quality in addition to the pre-defined channel and corresponding URL. The URL can be changed as described above.

The channel and/or bandwidth quality (and hence the URL) can be changed as frequently as desired. Accordingly, the processes for changing the channel configuration 403, 405, 407, 409 can loop.

Optionally, the procedure 401 can include receiving 411 a media stream from the URL on the packet network and transmitting the received media stream to a display device. The process of receiving 411 the media stream can be performed in parallel with the processes involved in changing the channel configuration 403, 405, 407, 409.

Accordingly, one or more embodiments provide a computer-implemented method, implemented on a streaming media box, for providing channel configuration in connection with a streaming media box on a packet network. The method can include receiving a selection of media stream from a remote control, wherein the selection is a pre-defined channel which is designated to correspond to a universal resource locator (URL) from which the media stream is received; determining the URL corresponding to the pre-defined channel; and changing a URL selection of the streaming media box to the determined URL.

The method further can provide that the selection is received over a wireless short range interface. Furthermore, according to one or more embodiments, changing the URL selection comprises transmitting the determined URL to the streaming media box. One or more embodiments also include receiving a selection of bandwidth quality, and changing the URL selection to the selected bandwidth quality. One or more embodiments also include receiving the media stream from the URL on the packet network, and transmitting the received media stream to an output device.

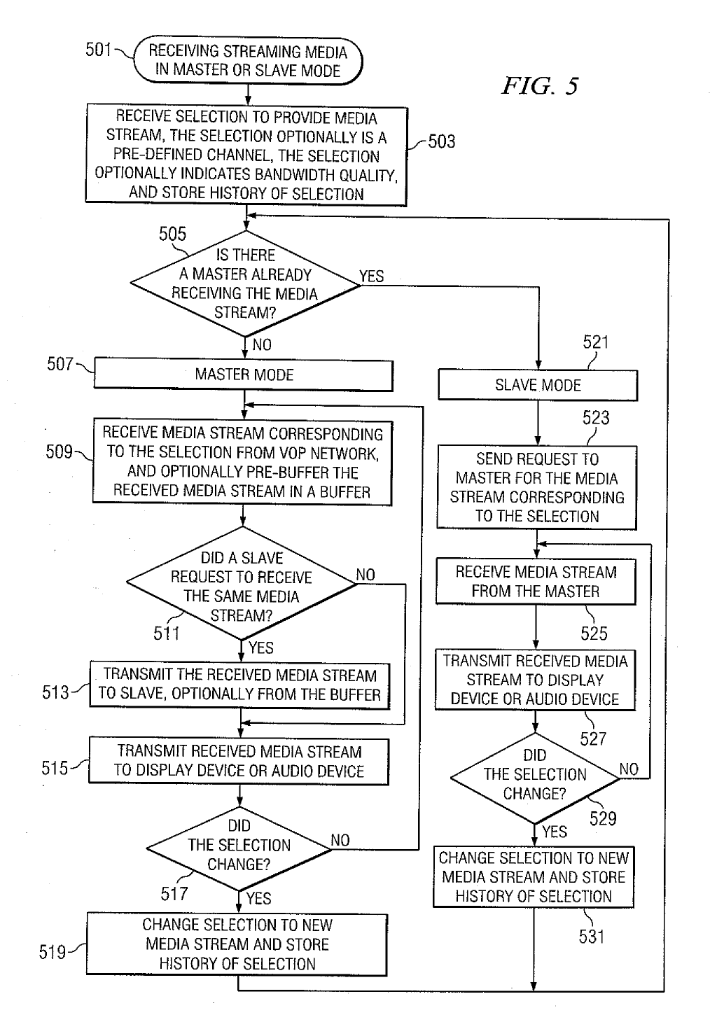

Referring now to FIG. 5, a flow chart illustrating a procedure for receiving streaming media in master or slave mode will be discussed and described. The illustrated procedure is a simplified representation, since more sophisticated processing may be provided to handle complications such as plural slaves and/or reception of parallel plural media streams. The procedure can advantageously be implemented on, for example, a processor of a controller of a streaming media receiving box described in connection with FIG. 2 or other apparatus appropriately arranged.

In overview, a procedure for receiving 501 streaming media in master or slave mode includes receiving 503 a selection to provide a media stream, where the selection optionally is a pre-defined channel, the selection optionally indicating bandwidth quality; checking 505 whether there is a master already receiving the media stream; if there is no master already receiving the media stream, operating in master mode 507; but if there is a master already receiving the media stream, operating in slave mode 521. Also, if the selection of media stream changes 517, 529 (in either master mode or slave mode), the procedure 501 loops to check whether it should be operating in master or slave mode for the new media stream.

The master mode 507 can include receiving 509 a media stream corresponding to the selection from the packet network, and optionally pre-buffering the received media stream in a buffer; checking 511 whether a slave requested to receive the same media stream; and if so, transmitting 513 the received media stream to the slave(s), optionally from the buffer; and transmitting the received media stream to a display device or an audio device. The slave mode 521 can include sending 523 a request to the master for the media stream corresponding to the selection; receiving 525 the media stream from the master; and transmitting 527 the received media stream to the display device or the audio device. Each of these is discussed in more detail below, except that details which were discussed above will not be repeated below.

The procedure 501 includes receiving 503 a selection to provide a media stream, where the selection optionally is a pre-defined channel, the selection optionally indicating bandwidth quality, such that the pre-defined channel corresponds to a particular media stream. A default channel can be provided so that the procedure initially uses the corresponding predefined URL by default until a different channel is selected. A history of the selection is stored; the history of selections can be used for example to track a viewing pattern. If, for example, the history of selections shows that a particular media stream is viewed often, then pre-buffering can be enabled, as discussed above.

The procedure 501 includes checking 505 whether there is a master already receiving the media stream. This can be done in any of the ways discussed above. Then, if there is no master already receiving the media stream, the procedure 501 can operate in master mode 507, but if there is a master already receiving the media stream, the procedure 501 can operate in slave mode 521 so as to receive the media stream from the master.

In the master mode 507, the procedure 501 receives 509 a media stream corresponding to the selection from the packet network, stores a history of the selection, and optionally pre-buffers the received media stream in a buffer. Also, if 511 a slave requested to receive the same media stream, the procedure transmits 513 the received media stream to the slave(s), optionally from the buffer. By transmitting the media stream from the buffer, the procedure 501 allows the slave and master to provide users at different televisions (for example) to asynchronously watch the same channel. Accordingly, an embodiment includes pre-buffering the received media stream in a buffer, wherein the received media stream which is transmitted to another streaming media box is transmitted from the buffer.

In addition, the procedure 501 can transmit the received media stream to a display device or an audio device, as further described above. If the selection of the media stream does not change 517, then the procedure loops back to continue with receiving 509 the media stream.

The slave mode 521 can include sending 523 a request to the master for the media stream corresponding to the selection, and receiving 525 the media stream from the master, as described above in more detail. As with the master mode 515, the slave mode 521 includes transmitting 527 the received media stream to the display device or the audio device. If the selection of the media stream does not change 529, then the procedure loops back to continue with receiving 525 the media stream from the master.

If the selection of media stream changes 517, 529 (in either master mode or slave mode), then the procedure 501 changes the selection to the new media stream and (optionally) stores the selection in a history of selections, and then the procedure 501 loops to check whether it should be operating in master or slave mode for the new media stream.

According to a variation, the procedure 501 can be set to always operate in master mode or to always operate in slave mode.

The procedures discussed in connection with FIG. 4 and/or FIG. 5 can be provided with specially programmed software and/or hardware. Accordingly, there can be provided a computer-readable medium comprising instructions being executed by a computer. The instructions can be directed to a computer-implemented method for providing a media stream in master or slave mode, and/or to a computer-implemented method for providing ease of user channel configuration.

The communication networks of interest include those that transmit information in packets, for example, those known as packet switching networks that transmit data in the form of packets, where messages can be divided into packets before transmission, the packets are transmitted, and the packets are routed over network infrastructure devices to a destination where the packets are recompiled into the message. Such networks include, by way of example, the Internet, intranets, local area networks (LAN), wireless LANs (WLAN), wide area networks (WAN), voice over packet (VOP) networks, and others. Protocols supporting communication networks that utilize packets include one or more of various networking protocols, such as TCP/IP (Transmission Control Protocol/Internet Protocol), Ethernet, X.25, Frame Relay, ATM (Asynchronous Transfer Mode), IEEE 802.11, UDP/UP (Universal Datagram Protocol/Universal Protocol), IPX/SPX (Inter-Packet Exchange/Sequential Packet Exchange), Net BIOS (Network Basic Input Output System), GPRS (general packet radio service), I-mode and other wireless application protocols, and/or other protocol structures, and variants and evolutions thereof. Such networks can provide wireless communications capability and/or utilize wireline connections such as cable and/or a connector, or similar.

The term “streaming media receiving box,” sometimes referred to as a “streaming media box,” is used herein to indicate a device which can receive a media stream in packet communications from a packet network, and typically can display or play the received media stream to an end-user. Such devices can receive a media stream in connection with Datagram protocols such as User Datagram Protocol (UDP), Real-time Streaming Protocol (RTSP), Real-time Transport Protocol (RTP), Real-time Transport Control Protocol (RTCP), Transmission Control Protocol (TCP), various UDP-based protocols, various TCP-based protocols, unicast protocols, multicast protocols such as IP Multicast, and peer-to-peer (P2P) protocols, and variants and evolutions of the foregoing.

The term “media stream” is used herein to refer to continuous sequential content that is constantly delivered by a content provider in the form of packet communications over a communications network. A media stream can provide video, audio, data, and/or a combination of any of the foregoing. A “media stream” is not delivered as a traditional television, radio or cable broadcast. A “media stream” is also to be distinguished from individual communications which do not provide continuous and/or sequential content.

The term “gateway” is used herein to specifically mean any of various devices providing or communicating on packet networks, that is, a hardware device connecting a local area network with a wide area network (WAN) or the Internet. The gateway can provide network address translation so as to allow processors in the local area network to share one IP address and Internet connection, and can include the functions of an IP router, multi-port Ethernet switch and/or wireless access point; the gateway may be located between a modem and the local area network, or a DSL or cable modem may be integrated into the gateway. The gateway can incorporate various proprietary devices and/or devices which are the subject of standardization efforts such as the Home Gateway Initiative (HGI), and the like, and variants or evolutions thereof. Such devices are sometimes colloquially referred to as “media gateways,” “residential gateways,” “home gateways,”, “home routers,” or “broadband routers.” The designation “VoIP gateway” is sometimes used herein to indicate such a gateway specifically including functionality to communicate using VoIP.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A streaming media receiving box in a packet network, comprising:
a first transceiver operable to transmit and receive communications over at least a portion of a packet network;
a second transceiver operable to transmit and receive communications over at least a portion of a local area network; and
a processor cooperatively operable with the first transceiver and the second transceiver, and configured to facilitate:
receiving a selection to provide a media stream;
operating in a master mode, including responsive to the selection, receiving the media stream from the packet network in accordance with the first transceiver; and transmitting the received media stream to another streaming media box in accordance with the second transceiver.

2. The streaming media receiving box of claim 1, further comprising receiving a request for the media stream from the another streaming media box, wherein the transmitting is responsive to the request.

3. The streaming media receiving box of claim 1, further comprising a television tuner interface, wherein the processor is configured for transmitting the received media stream to a display device over the tuner interface.

4. The streaming media receiving box of claim 1, further comprising an audio interface, wherein the processor is configured for transmitting the received media stream to an audio device over the audio interface.

5. The streaming media receiving box of claim 1, wherein the processor is further configured for pre-buffering the received media stream in a buffer, wherein the received media stream which is transmitted to the another streaming media box is transmitted from the buffer.

6. The streaming media receiving box of claim 1, further comprising a wireless short range interface operable to receive communications from a remote control, wherein the selection of the media stream is received from the remote control over the wireless short range interface, and the selection is a pre-defined channel which is designated to correspond to a universal resource locator (URL) from which the media stream is received.

7. The streaming media receiving box of claim 1, wherein the processor is further configured for receiving a selection of bandwidth quality, and changing the media stream to the selected bandwidth quality.

8. A streaming media receiving box in a packet network, comprising:
a first transceiver operable to transmit and receive communications over at least a portion of a local area network; and
a processor cooperatively operable with the first transceiver, and configured to facilitate:
receiving a selection to provide a media stream;
operating in a slave mode, responsive to the selection, including sending a request to another streaming media box for the media stream and receiving the media stream from the another streaming media box in accordance with the first transceiver.

9. The streaming media receiving box of claim 8, further comprising:
a second transceiver operable to transmit and receive communications over at least a portion of a packet network;
wherein the processor is cooperatively operable with the second transceiver, and is configured to facilitate
responsive to the selection, checking over the first transceiver whether another streaming media box is already receiving the media stream from the packet network, and operating in the slave mode if the another streaming media box is already receiving the media stream;
otherwise, operating in a master mode, including receiving the media stream from the packet network in accordance with the second transceiver.

10. The streaming media receiving box of claim 9, wherein the master mode includes receiving a request from the another streaming media box for the media stream and transmitting the received media stream to the another streaming media box in accordance with the first transceiver.

11. The streaming media receiving box of claim 10, wherein the processor is further configured for pre-buffering the received media stream in a buffer, wherein the received media stream which is transmitted to the another streaming media box is transmitted from the buffer.

12. The streaming media receiving box of claim 8, further comprising a television tuner interface, wherein the processor is configured for transmitting the received media stream to a display device over the tuner interface.

13. The streaming media receiving box of claim 8, further comprising an audio interface, wherein the processor is configured for transmitting the received media stream to an audio device over the audio interface.

14. The streaming media receiving box of claim 8, further comprising a wireless short range interface operable to receive communications from a remote control, wherein the selection of the media stream is received from the remote control over the short range interface, and the selection is a pre-defined channel which is designated to correspond to a universal resource locator (URL) from which the media stream is received.

15. The streaming media receiving box of claim 8, wherein the processor is further configured for receiving a selection of bandwidth quality, and changing the media stream to the selected bandwidth quality.

16. A computer-implemented method, implemented on a streaming media box, for providing channel configuration in connection with a streaming media box on a packet network, comprising:
receiving a selection of media stream from a remote control, wherein the selection is a pre-defined channel which is designated to correspond to a universal resource locator (URL) from which the media stream is received;
determining the URL corresponding to the pre-defined channel; and
changing a URL selection of the streaming media box to the determined URL.

17. The method of claim 16, wherein the selection is received over a wireless short range interface.

18. The method of claim 16, wherein changing the URL selection comprises transmitting the determined URL to the streaming media box.

19. The method of claim 16, further comprising receiving a selection of bandwidth quality, and changing the URL selection to the selected bandwidth quality.

20. The method of claim 16, further comprising receiving the media stream from the URL on the packet network, and transmitting the received media stream to an output device.
